(19) United States
(12) Patent Application Publication
(10) Pub. No.: US 2026/0153881 A1
(43) Pub. Date: Jun. 4, 2026

(54) SYSTEM AND METHOD FOR MANAGING OPERATIONS OF A CRAWLER VEHICLE IN A WORKING AREA

(71) Applicant: PRINOTH S.P.A., Vipiteno (IT)

(72) Inventors: Martin Kirchmair, Vipiteno (IT); Alberto Paoletti, Vipiteno (IT); Francesco Salis, Vipiteno (IT)

(21) Appl. No.: 19/394,560

(22) Filed: Nov. 19, 2025

(30) Foreign Application Priority Data
Nov. 29, 2024 (IT) 102024000027078
Dec. 18, 2024 (IT) 102024000028929
Feb. 6, 2025 (IT) 102025000002259

(51) Int. Cl. G05D 1/648; E01H 4/02; G05D 1/225; G05D 101/10; G05D 107/30; G05D 111/10

(52) U.S. Cl. CPC G05D 1/6484; G05D 1/225; E01H 4/02; G05D 2101/10; G05D 2107/30; G05D 2111/17

(57) ABSTRACT

A system for managing operations of a crawler vehicle in a working area having a crawler vehicle, which is configured to advance in the working area and comprises a working tool assembly and a control unit. The system comprising at least one detection device which is configured to detect operative data indicative of a status of the working area and is separate from the crawler vehicle. The system also comprises a processing device configured to process the operative data detected by the at least one detection device. The control unit of the crawler vehicle being configured to perform at least one of the following actions: send information indicative of the processed operative data to an interface screen; control the advancement of the crawler vehicle in the working area as a function of the processed operative data; control the working tool assembly as a function of the processed operative data.

### PRIORITY CLAIM

This application claims the benefit of and priority to Italian Patent Application No. 102024000027078, filed on Nov. 29, 2024, and claims the benefit of and priority to Italian Patent Application No. 102024000028929, filed on Dec. 18, 2024, and claims the benefit of and priority to Italian Patent Application No. 102025000002259, filed on Feb. 6, 2025, the entire contents of which are each incorporated by reference herein.

### TECHNICAL FIELD

The present disclosure relates to a system and method for managing operations of a crawler vehicle in a working area.

### BACKGROUND

Generally, a crawler type vehicle comprises a frame, a driver's cab, a propulsion system, a pair of motorized tracks, and, in certain instances, working tools.

Crawler vehicles are commonly used in an off-road working area to carry out a wide range of different jobs, such as for preparing a snowpack of ski runs or for cleaning beaches or for operations in agriculture.

Generally, the status of the working area in which the crawler vehicle operates may vary depending on the climatic-environmental conditions and/or the activities taking place in the working area. By way of example, the topographical conformation of the working area may vary depending on the season and the presence of obstacles and/or people in the working area is typically unpredictable in advance.

Currently, the management of the operations of one or more crawler vehicles in a working area is entrusted to the experience of the operators, who have a relatively poorly updated knowledge on the status of the entire working area. As a result, the management of the operations of crawler vehicles in the working area is not optimal.

### SUMMARY

An aim of the present disclosure is to provide a system for managing operations of a crawler vehicle in a working area that mitigates certain of the drawbacks of certain of the prior art.

In accordance with certain embodiments of the present disclosure a system for managing operations of a crawler vehicle in a working area is realized. In these embodiments, the system comprises a crawler vehicle, which is configured to advance in the working area and comprises a frame, a pair of motorized tracks, a working tool assembly, and a control unit. The system also comprises at least one detection device, which is configured to detect operative data indicative of a status of the working area and is separate from the crawler vehicle, and a processing device, which is in communication with the control unit of the crawler vehicle and with the at least one detection device, and is configured to process the operative data detected by the at least one detection device and to transmit the processed operative data to the control unit of the crawler vehicle. In these embodiments, the control unit of the crawler vehicle is configured to perform at least one of the following actions: sending information indicative of the processed operative data to an interface screen to enable a display of the information on the interface screen; controlling the advancement of the crawler vehicle in the working area as a function of the processed operative data; controlling the working tool assembly as a function of the processed operative data. In accordance with these embodiments of the present disclosure, it is possible to obtain information on the status of the working area, even at portions of the working area that are inaccessible or out of reach of the crawler vehicle, and to manage the operations of the crawler vehicle in the working area accordingly. In this way, it is possible to optimize the management of the resources and processing times in the working area. By way of example, based on the at least one detection device, it is possible to detect, in real time, the topographical conformation of the entire area to assign to the crawler vehicle activities and/or missions to be carried out as a function of the detected topographical conformation or provide updated information to the operator of the crawler vehicle.

Furthermore, in accordance with certain embodiments of the present disclosure, it is possible to optimally manage a fleet of crawler vehicles, assigning to each crawler vehicle a certain sequence of operations to be carried out in a certain zone of competence of the working area.

In accordance with certain embodiments, the system comprises at least one recognition vehicle of aerial and/or ground type, which is configured to advance in the working area and is equipped with the at least one detection device. In this way, it is possible to detect operative data indicative of a status of the working area from above and/or on the ground from a perspective out of reach of the crawler vehicle.

In accordance with certain embodiments, the system comprises at least one artificial satellite, which is configured to orbit around the planet Earth and is equipped with the at least one detection device. In this way, it is possible to detect operative data indicative of a status of the entire working area from an aerial perspective.

In accordance with certain embodiments, the at least one detection device is arranged in a fixed location in the working area or at boundaries of the working area. In this way, it is possible to detect operative data indicative of a status of the working area at specific points of interest of the working area and compare the operative data detected at different time points.

In certain embodiments, the processing device is arranged in a position remote from the crawler vehicle and the at least one detection device. In this way, it is possible to control the management of the system from a remote location, such as a valley station of a ski resort.

In certain embodiments, the system comprises a plurality of crawler vehicles. In this way, each crawler vehicle can be independently controlled to perform a plurality of different tasks in different areas of the working area.

In certain embodiments, the processing device is configured to process the operative data detected by the at least one detection device to determine, in real time, a status of at least a portion of the working area. In this way, it is possible to obtain real-time updated information on the status of the working area. By way of example, it is possible to detect, in real time, the presence of objects and/or people in the working area and/or to detect the conformation of zones of the working area that represent blind spots for the crawler vehicle.

In certain embodiments, the processing device is configured to process the operative data detected by the at least one detection device to determine a topographical conformation of the working area. In this way, it is possible to detect the topographical conformation of the working area at different time instants and compare the detected topographical conformations with each other. By way of example, it is possible to detect the topographical conformation of the working area in different seasons. In addition or alternative embodiments, it is possible to detect the topographical conformation of the working area before and after working of the working area by the crawler vehicle. In this way, it is possible to define a reference surface, a current surface and a target surface in the working area.

In certain embodiments, the processing device is configured to process the operative data detected by the at least one detection device to detect a position and/or a conformation of reference elements in the working area. In this way, it is possible to avoid any obstacles along the path of the crawler vehicle and/or simplify the control of the crawler vehicle to enable the crawler vehicle to be driven even by a driver with relatively little experience. In additional embodiments, it is possible to control the advancement of the crawler vehicle, even remotely, without the need to keep the driver aboard the crawler vehicle.

A further aim of the present disclosure is to realize a method for managing operations of a crawler vehicle in a working area that mitigates certain of the drawbacks of certain of the prior art. In accordance with certain embodiments of the present disclosure a method for managing operations of a crawler vehicle in a working area is realized. In these embodiments, the method comprises detecting operative data indicative of a status of the working area via at least one detection device separate from the crawler vehicle, and processing the detected operative data. The method further comprises performing at least one of the following actions: sending information indicative of the processed operative data to an interface screen to enable a display of the information on the interface screen, controlling the advancement of the crawler vehicle in the working area as a function of the processed operative data, and/or controlling the working tool assembly of the crawler vehicle as a function of the processed operative data. In accordance with this method, it is possible to obtain updated information on the status of the working area and, consequently, optimally manage the operations carried out by the crawler vehicle taking into account this information.

### BRIEF DESCRIPTION OF THE DRAWINGS

Further characteristics and advantages of the present disclosure will become clear from the following description of non-limiting examples of embodiment thereof, with reference to the figures of the attached drawings, wherein:

FIG. 1 is a view, with parts removed for clarity and schematised parts, of a system for managing operations of a crawler vehicle in a working area realized in accordance with the present disclosure;

FIG. 2 is a side view, with schematised parts and parts removed for clarity, of a crawler vehicle of the system of FIG. 1; and

FIG. 3 is a flowchart of a method for managing operations of the crawler vehicle of FIG. 2 in a working area.

### DETAILED DESCRIPTION

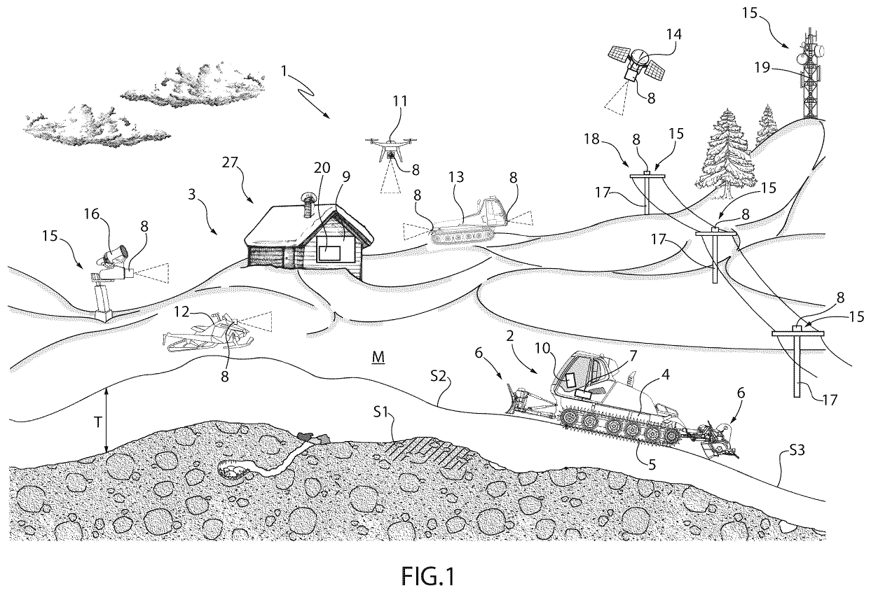

With reference to FIG. 1, number 1 denotes as a whole a system configured to manage operations of a crawler vehicle 2 in a working area 3, such as off-road.

In a non-limiting embodiment of the present disclosure, the working area 3 comprises a snowpack M of ski runs and the crawler vehicle 2 is used for preparing the snowpack M. In certain embodiments, the crawled vehicle 2 is a snow groomer. In more detail, the crawler vehicle 2 of these embodiments is used for preparing one or more of downhill ski runs, cross-country ski runs, ski-jumping ramps, half-pipe ski runs, snow-parks, and/or snowmobile tracks.

In accordance with a further embodiment, the working area 3 can be a sandy area, such as a beach, and the crawler vehicle 2 can be used for the maintenance of the sandy area. In addition or alternative embodiments, the working area 3 can be an agricultural field and the crawler vehicle 2 can be used for operations in the agricultural field, such as one or more of harvesting agricultural produces, handling agricultural products, forage silage, bagasse harvesting and/or bagasse handling.

In additional embodiments, in accordance with a further embodiment (not shown in the figures), the crawler vehicle 2 can comprise a shredder, such as a shredder positioned at the front of the crawler vehicle 2, that can be used for shredding vegetation.

In accordance with certain embodiments of the present disclosure, the system 1 comprises the crawler vehicle 2, which is configured to advance in the working area 3 and comprises a frame 4, a pair of motorized tracks 5 (only one of which is visible in FIG. 1), a working tool assembly 6, and a control unit 7.

Furthermore, the system 1 of certain embodiments comprises at least one detection device 8, which is configured to detect operative data indicative of a status of the working area 3 and is separate from the crawler vehicle 2; and a processing device 9, which is in communication with the control unit 7 of the crawler vehicle 2 and with the at least one detection device 8, and is configured to process the operative data detected by the at least one detection device 8 and transmit the processed operative data to the control unit 7 of the crawler vehicle 2. In such embodiments, the control unit 7 of the crawler vehicle 2 is configured to perform at least one of the following actions: sending information indicative of the processed operative data to an interface screen 10 to enable a display of the information on the interface screen 10, controlling the advancement of the crawler vehicle 2 in the working area 3 based on or as a function of the processed operative data, and/or controlling the working tool assembly 6 based on or as a function of the processed operative data.

In certain embodiments, the status of the working area 3 comprises the topographical conformation of the working area 3 and/or the presence of obstacles, such as people and/or objects, in the working area 3. In more detail, the topographic conformation of the working area 3 comprises, for example, the thickness or any irregularities of the snowpack M.

In a non-limiting embodiment of the present disclosure, the system 1 comprises a plurality of crawler vehicles 2, such as a fleet of crawler vehicles 2.

Furthermore, the system 1 of certain embodiments comprises a plurality of detection devices 8. In certain embodiments, each detection device 8 comprises one or more of a lidar, a radar, an infrared video camera, a stereoscopic camera, a camera and/or a video camera such as at 270° or 360°.

In accordance with certain variant embodiments of the present disclosure, each detection device 8 comprises a thermographic camera configured to acquire thermographic images and/or thermographic videos of the environment surrounding the crawler vehicle 2. In certain embodiments, each detection device 8 comprising a thermographic camera that enables detection of one or more of: snow temperature(s); snow humidity; air temperature(s); air humidity; snowpack profile M (i.e., based on the temperature difference between snowpack M and air); and/or a distinguishment between a worked surface of snowpack M and an unworked surface of snowpack M. In these embodiments, the use of the thermographic camera is particularly useful in conditions of relatively poor visibility, such as at night or in foggy conditions.

In accordance with certain embodiments, the detection device 8 is not arranged aboard the crawler vehicle 2. In accordance with the embodiment shown in FIG. 1, the system 1 comprises at least one recognition vehicle 11, 12, 13 of the aerial type and/or ground type, which is configured to advance in the working area 3 and is equipped with the detection device 8. In other words, the detection device 8 is arranged aboard the recognition vehicle 11, 12, 13. In more detail, the detection device 8 is facing in a travelling direction of the recognition vehicle 11, 12, 13, in a direction substantially opposite to the travelling direction or in a direction transverse to the travelling direction.

In certain embodiments, the recognition vehicle 11 is an unmanned aerial vehicle, such as an aerial drone, configured to detect, from above, operative data indicative of a status of the working area 3 by the detection device 8. In certain instances, the recognition vehicle 12 is a snowmobile configured to detect, from the ground, operative data indicative of a status of the working area 3 via the detection device 8. In certain instances, the recognition vehicle 13 is a further crawler vehicle equipped with the detection device 8 configured to detect, from the ground, operative data indicative of a status of the working area 3.

Furthermore, the system 1 of certain embodiments comprises at least one artificial satellite 14, which is configured to orbit around the planet Earth and is equipped with the detection device 8. In other words, the detection device 8 is arranged aboard the artificial satellite 14.

In certain embodiments, one or more of the detection devices 8 may be arranged in respective fixed stations 15 in the working area 3 and/or at boundaries of the working area 3. In a non-limiting embodiment of the present disclosure, the system 1 comprises a snow generator 16, (e.g., a snow cannon or lance) on which the detection device 8 is mounted and/or a support pylon 17 for a rope transport system 18 on which the detection device 8 is mounted; and/or a telecommunications tower 19 on which the detection device 8 is mounted.

It should be appreciated that the detection devices 8 are not necessarily arranged aboard all the recognition vehicles 11, 12, 13, of the artificial satellite 14, and mounted on all the fixed stations 15 mentioned above. For example, the system 1 may comprise a single detection device 8 arranged aboard one of the recognition vehicles 11, 12, 13 and the artificial satellite 14 and/or arranged in one of the fixed stations 15.

In accordance with certain embodiments, the processing device 9 is arranged in a position remote from the crawler vehicle 2 and the detection devices 8. In the embodiments described and shown, the processing device 9 is arranged in a remote control station 27, such as a valley station of a ski resort.

In accordance with alternative embodiments (not shown in the figures), the processing device 9 is arranged aboard the crawler vehicle 2.

In certain embodiments, the processing device 9 is equipped with wireless communication modules and is configured to receive operative data from the detection device 8 and the control unit 7 of the crawler vehicle 2, to process the received operative data, and to send control signals to the control unit 7 to control the crawler vehicle 2 based on or as a function of the processed operative data.

In certain embodiments, the processing device 9 comprises a Central Processing Unit (“CPU”) and implements one or more artificial intelligence algorithms. In more detail, the processing device 9 is configured to process the operative data detected by the detection devices 8 to determine, in real time, a status of at least a portion of the working area 3. For example, the processing device 9 is configured to process videos and/or images detected by one of the detection devices 8 to monitor, in real time, a presence of people and/or objects in the working area 3 and/or to provide a view of the working area 3 from a perspective other than the perspective of the crawler vehicle 2 to prevent blind spots. In the event that the working area 3 comprises a ski resort, the processing device 9 is configured to process videos and/or images detected by one of the detection devices 8 to monitor a presence of skiers and/or obstacles on the ski runs.

In additional embodiments, the processing device 9 is configured to process the operative data detected by the detection devices 8 to determine a topographical conformation of the working area 3. In certain embodiments, the processing device 9 is configured to determine the topographical conformation of the working area 3 at different time instants and compare the detected topographical conformations with each other. By way of example, in the event that the working area 3 comprises a ski resort, the processing device 9 is configured to determine a reference surface S1, where the working area 3 is free of snow. In certain embodiments, the processing device 9 is configured to determine the reference surface S1 by processing the operative data detected by the detection device 8 during a hot season, such as the boreal summer.

The processing device 9 of certain embodiments is further configured to determine a current surface S2, in which the working area 3 is covered by the snowpack M. In certain such embodiments, the processing device 9 is configured to determine the current surface S2 by processing the operative data detected by the detection device 8 during a cold season, such as the boreal winter.

In accordance with certain embodiments, the processing device 9 is configured to calculate a thickness T of the snowpack M in the working area 3 based on or as a function of the determined reference surface S1 and the determined current surface S2. In certain such embodiments, the processing device 9 is configured to determine the thickness T of the snowpack M at each point of the working area 3 by calculating a difference between an altitude HS2 at a given point of the current surface S2 and an altitude HS1 at a corresponding point of the reference surface S1. In other words: T=HS2−HS1. In other words, the processing device 9 is configured to determine the thickness T of the snowpack M also at a point of the working area 3 outside the range and/or field of view of the crawler vehicle 2, such as before the crawler vehicle 2 travels along the point of the working area 3.

Furthermore, the processing device 9 of certain embodiments is configured to determine a target surface S3 based on or as a function of the determined reference surface S1 and the determined current surface S2. In more detail, the processing device 9 is configured to determine the target surface S3 based on or as a function of the determined thickness T of the snowpack M. The term “target surface S3” means a surface of the snowpack M that is desired to be obtained following a processing of the snowpack M by the working tool assembly 6 of the crawler vehicle 2.

In accordance with a non-limiting embodiment of the present disclosure, the processing device 9 comprises a memory 20, in which one or more of the determined reference surface S1, the determined current surface S2, the determined target surface S3 and/or the thickness T of the snowpack M is stored. In certain such embodiments, the memory 20 is configured to contain one or more of a first three-dimensional model of the determined reference surface S1, a second three-dimensional model of the determined current surface S2, a third three-dimensional model of the determined target surface S3 and/or a fourth three-dimensional model of the thickness T of the snowpack M.

In additional or alternative embodiments, the target surface S3 may be stored, a priori, in the memory 20, in certain instances without being determined by the processing device 9, based on or as a function of the reference surface S1 and the current surface S2.

In accordance with certain embodiments, the processing device 9 is configured to process the operative data detected by the detection devices 8 to assign tasks and/or missions to each crawler vehicle 2. In certain such embodiments, the processing device 9 is configured to assign the tasks and/or missions to each crawler vehicle 2 based on or as a function of the determined topographical conformation of the working area 3 and/or of the status determined, in real-time, of the working area 3. By way of example, the processing device 9 is configured to assign a surface working activity of a first zone of the working area 3 to one of the crawler vehicles 2 and to assign to a further crawler vehicle 2 a rescue mission to be carried out in a second zone of the working area 3. In more detail, in the event that the working area 3 comprises a ski resort, the processing device 9 is configured to assign to one of the crawler vehicles 2 a snowpack processing activity M of the first zone of the working area 3 and to assign to a further crawler vehicle 2 a rescue mission to rescue a skier to be carried out in a second zone of the working area 3.

Furthermore, the processing device 9 of certain embodiments is configured to process the operative data detected by the detection device 8 to identify a position and/or a conformation of reference elements in the working area 3. In certain embodiments, the processing device 9 is configured to identify a position of objects and/or living beings in the working area 3 based on or as a function of the processed operative data. By way of example, the reference elements may comprise one or more of buildings, poles, snow generators, people, snow groomers and/or snowmobiles. In more detail, the memory 20 of the processing device 9 is configured to store a database containing comparison images of a plurality of reference elements of different types. The processing device 9 is configured to classify each reference element based on or as a function of the processed operative data and the comparison images stored in the database. By way of example, the processing device 9 is configured to classify each reference element as an obstacle or as a boundary element delimiting an area that can be travelled by the crawler vehicle 2 or as a component of the crawler vehicle 2 (e.g., a working tool 6 of the crawler vehicle 2).

In certain embodiments, the artificial intelligence algorithms implemented by the processing device 9 employ pre-trained convolutional neural networks configured to detect and classify the reference elements. In accordance with a non-limiting embodiment of the present disclosure, the artificial intelligence algorithms comprise object detection models, such as the “YOLO—(You Only Look Once)” model.

In certain embodiments, the processing device 9 is configured to calculate a distance of each identified reference element from the crawler vehicle 2 based on or as a function of the processed operative data. By way of example, the processing device 9 implements a “Monocular Depth Estimation” type algorithm, which is configured to estimate the distance of reference elements by receiving images and/or videos detected by a single camera as an input.

In certain embodiments, the processing device 9 is configured to define an area that can be travelled by the crawler vehicle 2 based on or as a function of the identified position and/or the identified conformation of the reference elements and to plan an optimal advancement path within the area that can be travelled by the crawler vehicle 2 to avoid collisions with any reference elements classified as obstacles.

In certain embodiments, the processing device 9 is configured to process, in real time, a sequence of digital images of the working area 3 based on or as a function of the operative data detected by the detection device 8. In more detail, the processing device 9 is configured to detect and/or indicate the contours of each reference element in the sequence of processed digital images. By way of example, the artificial intelligence algorithms implemented by the processing device 9 comprise deep learning models, such as a “Semantic Segmentation” type model, which associate a category with each unitary element, such as each pixel, of the digital image processed to group similar unitary elements in the same category.

From the operational point of view, the processing device 9 of certain embodiments is configured to send the processed operative data to the control unit 7 of the crawler vehicle 2. In certain such embodiments, the sent operative data is indicative of one or more of a real-time status of at least a portion of the working area 3, a topographical conformation of the working area 3, activities and/or missions to be assigned to the crawler vehicle 2, and/or a position and/or conformation of reference elements in the working area 3.

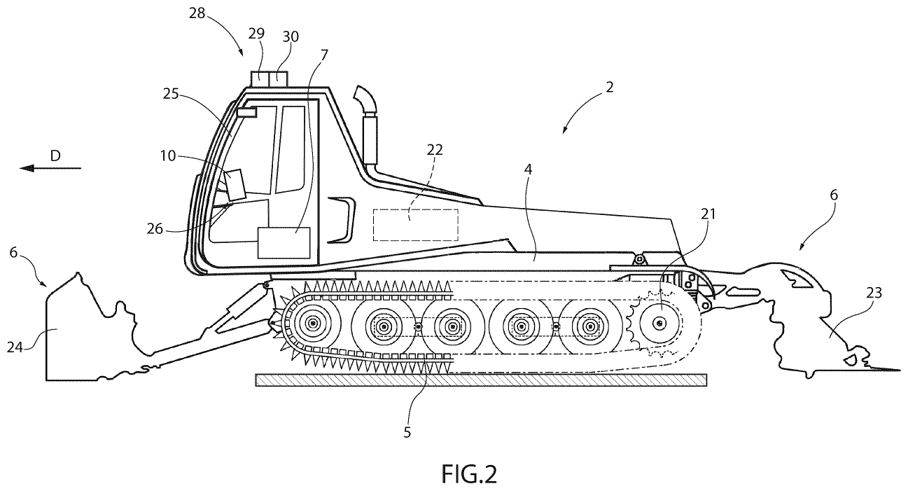

With reference to FIG. 2, the crawler vehicle 2 comprises a pair of drive wheels 21 (only one of which is visible in FIG. 2), each of which is coupled to a respective track 5; and a propulsion system 22 (e.g., internal combustion or electric or hydrogen-powered) configured to transmit power to the drive wheels 21.

In a non-limiting embodiment of the present disclosure, the working tool assembly 6 comprises at least one working tool 6 movably connected to the frame 4. In certain embodiments, the working tool assembly 6 comprises a tiller 23, a shovel 24, and a winch (not shown in the figures). It is understood that the crawler vehicle 2 does not necessarily comprise all the working tools 6 mentioned above. For example, the crawler vehicle 2 may comprise any one or two of the working tools 6 selected from the tiller 23, the shovel 24 and the winch.

Furthermore, in a non-limiting embodiment of the present disclosure, the crawler vehicle 2 comprises a cab 25 mounted on the frame 4 and a user interface 26, which is arranged in the cab 25 and is provided with the interface screen 10 configured to receive from the control unit 7 the information indicative of the operative data processed by the processing device 9. In accordance with an embodiment (not shown in the figures), the user interface 26 comprises a plurality of interface screens 10.

In accordance with certain alternative embodiments (not shown in the figures), the crawler vehicle 2 is without a cab and the user interface 26 is arranged at a remote location, such as the remote control station 27 (FIG. 1).

In certain embodiments, the crawler vehicle 2 comprises a sensor assembly 28, which is in communication with the control unit 7 and is configured to detect further operative data comprising one or more of operational parameters of the crawler vehicle 2, information about the operations to be performed and/or information about the characteristics of the environment surrounding the crawler vehicle 2.

In certain embodiments, the sensor assembly 28 comprises an acquisition device 29, such as one or more of a lidar, a radar, an infrared video camera, a stereoscopic camera, a camera and/or a video camera (e.g. at 270° or 360°) configured to detect operative data on the environment surrounding the crawler vehicle 2 and/or a satellite navigation device 30 (e.g., a Global Navigation Satellite System (“GNSS”) type device) which is configured to detect the position and three-dimensional orientation of the crawler vehicle 2. In more detail, the acquisition device 29 is facing in a travelling direction D of the crawler vehicle 2, in a direction substantially opposite to the travelling direction D or in a direction transverse to the travelling direction D.

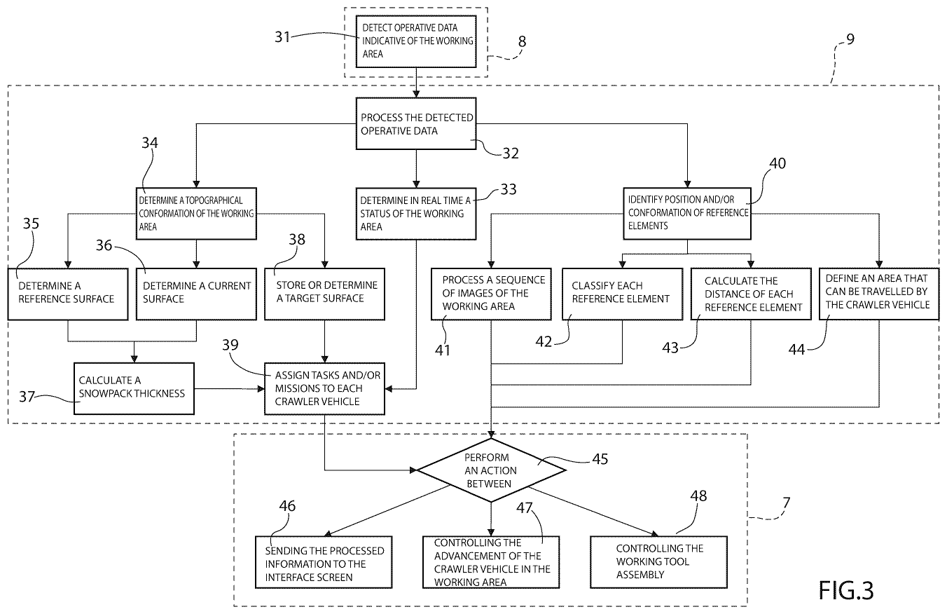

In use and with reference to FIG. 3, the detection devices 8 detect operative data indicative of a status of the working area 3 and transmit the detected operative data to the processing device 9 (block 31).

The processing device 9 of these embodiments receives the operative data detected by the detection devices 8 processes the received operative data (block 32).

In certain embodiments, the processing device 9 determines, in real time, a status of at least a portion of the working area 3 (block 33). For example, the processing device 9 processes videos and/or images detected by one of the detection devices 8 to monitor, in real time, a presence of people and/or objects in the working area 3.

Furthermore, the processing device 9 of certain embodiments determines a topographical conformation of the working area 3 (block 34). In certain such embodiments, the processing device 9 determines the topographical conformation of the working area 3 at different time instants and compares the detected topographical conformations with each other. In more detail, in the event that the working area 3 comprises a ski resort, the processing device 9 determines a reference surface S1 (block 35), where the working area 3 is free of snow, and a current surface S2 (block 36), where the working area 3 is covered by the snowpack M. At this point, the processing device 9 calculates a thickness T of the snowpack M in the working area 3 based on or as a function of the determined reference surface S1 and the determined current surface S2 (block 37).

Furthermore, the processing device 9 of certain embodiments stores, a priori, a target surface S3 or determines the target surface S3 based on or as a function of the determined reference surface S1 and the determined current surface S2 (block 38).

At this point, the processing device 9 assigns tasks and/or missions to each crawler vehicle 2 based on or as a function of the determined topographical conformation of the working area 3 and/or the determined real-time status of the working area 3 (block 39). In certain embodiments, the processing device 9 assigns tasks and/or missions to each crawler vehicle 2 based on or as a function of the calculated thickness T of the snowpack and/or the stored or determined target surface S3.

In certain embodiments, the processing device 9 additionally or alternatively identifies a position and/or a conformation of reference elements in the working area 3 (block 40). In certain such embodiments, the processing device 9 identifies a position of objects and/or living beings in the working area 3 based on or as a function of the processed operative data. In more detail, the processing device 9 undertakes one or more of: processes, in real time, a sequence of digital images of the working area 3 (block 41), classifies each reference element based on or as a function of the comparison images stored in the database (block 42), calculates a distance of each reference element identified by the crawler vehicle 2 based on or as a function of the identified position of the reference elements (block 43) and/or defines an area that can be travelled by the crawler vehicle 2 based on or as a function of the identified position and/or the identified conformation of the reference elements (block 44).

The processing device 9 of certain embodiments sends to the control unit 7 of the crawler vehicle 2 the processed operative data indicative of one or more of the real-time status of at least a portion of the working area 3, the topographical conformation of the working area 3, activities and/or missions to be assigned to the crawler vehicle 2 and/or the position and/or conformation of reference elements in the working area 3.

At this point, the control unit 7 of the crawler vehicle 2 performs at least one of the following actions (block 45): sends information indicative of the processed operative data to the interface screen 10 to enable a display of the information on the interface screen 10 (block 46); controls the advancement of the crawler vehicle 2 in the working area 3 based on or as a function of the processed operative data (block 47); and/or controls the working tool assembly 6 based on or as a function of the processed operative data (block 48). In more detail, the control unit 7 determines an operating configuration of the tool assembly 6 based on or as a function of the processed operative data, in particular based on or as a function of the thickness T of the snowpack M and/or of the target surface S3, and controls the tool assembly 6 so that the tool assembly 6 assumes the determined operating configuration.

In certain embodiments, depending on the actions performed by the control unit 7, the crawler vehicle 2 can be used in one or more of the following operating modes: a first fully autonomous operating mode, in which the control unit 7 plans the optimal advancement path and controls the crawler vehicle 2 so that the crawler vehicle follows the optimal advancement path and/or performs the tasks and/or missions assigned by the processing device 9; and a second partially assisted operating mode, in which the advancement of the crawler vehicle 2 is controlled by a driver assisted by the information indicative of the processed operative data displayed on the interface screen 10.

In certain embodiments, in accordance with certain variant embodiments of the present disclosure (not shown in the figures), instead of the crawler vehicle 2, the system 1 may comprise a vehicle without tracks.

It is evident that variants can be made to the present disclosure without, however, departing from the scope of protection of the appended claims. That is, the present disclosure also covers embodiments that are not described in the detailed description above as well as equivalent embodiments that are part of the scope of protection set forth in the claims. Accordingly, various changes and modifications to the presently disclosed embodiments will be apparent to those skilled in the art.

The invention is claimed as follows:

1. A system comprising:
a crawler vehicle configured to advance in a working area and comprising a frame, a pair of motorized tracks, a working tool assembly, and a control unit;
a detection device that is separate from the crawler vehicle and configured to detect operative data indicative of a status of the working area; and
a processing device in communication with the control unit of the crawler vehicle and with the detection device, the processing device configured to process the operative data detected by the detection device and to transmit the processed operative data to the control unit of the crawler vehicle,
wherein the control unit of the crawler vehicle is configured to perform at least one of:
sending information indicative of the processed operative data to an interface screen to enable a display of the information on the interface screen,
controlling, based on the processed operative data, an advancement of the crawler vehicle in the working area, and
controlling, based on the processed operative data, the working tool assembly.

2. The system of claim 1, wherein the detection device comprises at least one of a lidar, a radar, an infrared camera, a stereoscopic camera, a camera and a video camera.

3. The system of claim 1, further comprising a recognition vehicle of at least one of an aerial type and a ground type, wherein the recognition vehicle is configured to advance in the working area and is equipped with the detection device.

4. The system of claim 1, further comprising an artificial satellite configured to orbit around the planet Earth and equipped with the detection device.

5. The system of claim 1, wherein the detection device is arranged at one of in a fixed location in the working area and at a boundary of the working area.

6. The system of claim 1, wherein the processing device is arranged in a position remote from the crawler vehicle and from the detection device.

7. The system of claim 1, further comprising a plurality of crawler vehicles.

8. The system of claim 1, wherein the processing device is configured to process the operative data detected by the detection device to determine, in real time, a status of at least a portion of the working area.

9. The system of claim 1, wherein the processing device is configured to process the operative data detected by the detection device to determine a topographical conformation of the working area.

10. The system of claim 1, wherein the processing device is configured to process the operative data detected by the detection device to detect at least one of a position of reference elements in the working area and a conformation of reference elements in the working area.

11. The system of claim 1, wherein the processing device is configured to process, in real time and based on the processed operative data, a sequence of digital images of the working area.

12. The system of claim 10, wherein the processing device comprises a memory that stores a database containing comparison images of a plurality of reference elements of different types and the processing device is configured to classify each reference element based on the processed operative data and of the comparison images stored in the database.

13. The system of claim 1, wherein the processing device is configured to process the operative data detected by the detection device to define, based on the processed operative data, an area travelable by the crawler vehicle.

14. The system of claim 1, wherein the processing device implements an artificial intelligence algorithm.

15. The system of claim 1, wherein the crawler vehicle comprises a cab mounted on the frame and a user interface which is arranged in the cab and comprises the interface screen configured to receive and display the information indicative of the processed operative data.

16. A method of managing operations of a crawler vehicle in a working area, the method comprising:
detecting operative data indicative of a status of the working area by a detection device separate from the crawler vehicle;
processing the detected operative data; and
performing at least one of:
sending information indicative of the processed operative data to an interface screen to enable a display of the information on the interface screen,
controlling, based on the processed operative data, an advancement of the crawler vehicle in the working area, and
controlling, based on the processed operative data, a working tool assembly of the crawler vehicle.

17. The method of claim 16, further comprising advancing, in the working area, a recognition vehicle of at least one of an aerial type and a ground type, equipped with the detection device.

18. The method of claim 16, further comprising arranging the detection device aboard an artificial satellite orbiting around the planet Earth.

19. The method of claim 16, further comprising arranging the detection device in one of a fixed location in the working area and at a boundary of the working area.

20. The method of claim 16, further comprising processing the operative data detected by the detection device to determine, in real time, at least one of a status of at least a portion of the working area and a topographical conformation of the working area.

21. A non-transitory computer-readable medium that stores a plurality of instructions that, when executed by a computer, cause the computer to:
detect operative data indicative of a status of a working area by a detection device separate from a crawler vehicle;
process the detected operative data; and
perform at least one of:
sending information indicative of the processed operative data to an interface screen to enable a display of the information on the interface screen,
controlling, based on the processed operative data, an advancement of the crawler vehicle in the working area, and
controlling, based on the processed operative data, a working tool assembly of the crawler vehicle.
